(19) United States
(12) Patent Application Publication
(10) Pub. No.: US 2022/0029799 A1
(43) Pub. Date: Jan. 27, 2022

(54) SYSTEM AND METHOD FOR CREATING ONE OR MORE HASHES FOR BIOMETRIC AUTHENTICATION IN REAL-TIME

(71) Applicant: Signzy Technologies Private Limited, Mumbai (IN)

(72) Inventors: Shiv Shankar SUBUDHI, Mumbai (IN); Pragati GARG, Mumbai (IN); Aadalarasan Bhavani SARAVANAN, Mumbai (IN); Chitrangada PATRA, Mumbai (IN); Dinesh AVULA, Mumbai (IN); Ankit RATAN, Mumbai (IN); Arpit RATAN, Mumbai (IN); Ankur PANDEY, Mumbai (IN)

(73) Assignee: Signzy Technologies Private Limited, Mumbai (IN)

(21) Appl. No.: 17/126,038

(22) Filed: Dec. 18, 2020

(51) Int. Cl. H04L 9/08; H04L 9/32; H04L 9/06

(52) U.S. Cl. CPC H04L 9/0866; H04L 9/0643; H04L 9/3231

(57) ABSTRACT

The present disclosure provides a method and system for creating one or more hashes for a user. The method includes a first step to collect biometric information associated with the user. The method includes another step to create one or more hashes based on the biometric information associated with the user. The method includes another step to scan the biometric information associated the user. The method includes another step to map the biometric information associated with the user scanned in real-time with the collected biometric information associated with the user. The method includes another step to authenticate the user in real-time.

### TECHNICAL FIELD

The present invention relates to the field of biometric technology and in particular, relates to a system and method for creating one or more hashes for biometric authentication in real-time.

### Introduction

Over the last few years, authentication technology such as biometric authentication is utilized in a variety of scenarios for identification of human traits. The variety of scenarios include system logons, building security access, web-based authentication, and so on. In addition, the biometric authentication facilitates identification of different characteristic traits of a person. Further, the different characteristic traits of the person includes retina scan, fingerprint scan, face scan, voice scan and the like. Generally, the biometric authentication stores physical and behavioral characteristics of human. Conventionally, the biometric information of humans is processed by a predefined algorithm, converted into digital data, and the digital data is stored in database. During authentication of the user, the biometric information of the user is again captured and further processed in real-time. The newly obtained biometric information is compared with the existing biometric information stored in the database to determine whether there is match. The biometric authentication facilitates verification of personal identity of the person. However, the biometric information stored in the database is vulnerable to security breaches and cyber-attacks. In addition, the biometric information stored in the database can lead to huge amount of losses if the information is accessed by a hacker. Therefore, the storage of biometric information in database is not secure and requires suitable protection.

### SUMMARY

In a first example, a computer-implemented method is provided. The computer-implemented method creates one or more hashes for a user. The one or more hashes are created for performing biometric authentication of the user in real-time. The computer-implemented method includes a first step to collect biometric information associated with the user at a biometric authentication system with a processor. The computer-implemented method includes another step to create one or more hashes based on the biometric information associated with the user. The computer-implemented method includes another step to scan the biometric information associated the user. The computer-implemented method includes another step to map the biometric information associated with the user scanned in real-time with the collected biometric information associated with the user. The computer-implemented method includes another step to authenticate the user in real-time. The one or more hashes are created by encrypting the biometric information associated with the user. The one or more hashes are stored in a database. The one or more hashes are created for onboarding the user with the biometric authentication system. The biometric authentication system scans the biometric information associated with the user in real-time. Scanning of the biometric information associated with the user is performed for authenticating the user in real-time. The biometric authentication system scans the biometric information associated with the user in real-time. Scanning of the biometric information associated with the user is performed for authenticating the user in real-time. The mapping is performed by recognizing and converting the biometric information associated with the user into the one or more hashes in real-time. The one or more hashes are mapped with the one or more hashes created by scanning the biometric information associated with the user. The authentication is performed for providing access to the user in real-time.

In an embodiment of the present disclosure, the biometric authentication system generates a user profile of the user. The user profile is generated for storing the one or more hashes created by encrypting the biometric information associated with the user in real-time.

In an embodiment of the present disclosure, the biometric information is collected by scanning the biometric information associated with the user from one or more angles and one or more orientations in real-time.

In an embodiment of the present disclosure, the media device includes at least one of digital cameras, webcams, smart phones, laptops, closed-circuit television cameras and optical devices.

In an embodiment of the present disclosure, the biometric information associated with the user includes at least one of facial information, fingerprint impressions, hand geometry biometrics, retina scan, iris scan, signature and voice analysis.

In an embodiment of the present disclosure, the biometric authentication system facilitates in securing private and confidential information or assets of the user. The biometric authentication system is installed at a facility. The facility includes at least one of building, organization, institution, and skyscraper.

In an embodiment of the present disclosure, the biometric authentication system evaluates a measure of similarity between the one or more hashes created for the user in real-time with the one or more hashes created by analyzing the biometric information associated with the user. The evaluation of the measure of similarity is performed for authenticating the user in real-time.

In an embodiment of the present disclosure, the biometric authentication system sends one or more notifications to an administrator associated with the biometric authentication system. The one or more notifications are sent to the administrator in real-time.

In a second example, a computer system is provided. The computer system includes one or more processors, and a memory. The memory is coupled to the one or more processors. The memory stores instructions. The memory is executed by the one or more processors. The execution of the memory causes the one or more processors to create one or more hashes for a user. The one or more hashes are created for performing a method for biometric authentication of the user in real-time. The method includes a first step to collect biometric information associated with the user. The method includes another step to create one or more hashes based on the biometric information associated with the user. The method includes another step to scan the biometric information associated the user. The method includes another step to map the biometric information associated with the user scanned in real-time with the collected biometric information associated with the user. The method includes another step to authenticate the user in real-time. The one or more hashes are created by encrypting the biometric information associated with the user. The one or more hashes are stored in a database. The one or more hashes are created for onboarding the user with the biometric authentication. The biometric authentication system scans the biometric information associated with the user in real-time. Scanning of the biometric information associated with the user is performed for authenticating the user in real-time. The biometric authentication system scans the biometric information associated with the user in real-time. Scanning of the biometric information associated with the user is performed for authenticating the user in real-time. The mapping is performed by recognizing and converting the biometric information associated with the user into the one or more hashes in real-time. The one or more hashes are mapped with the one or more hashes created by scanning the biometric information associated with the user. The authentication is performed for providing access to the user in real-time.

In an embodiment of the present disclosure, the biometric authentication system generates a user profile for the user. The user profile is generated for storing the one or more hashes created by encrypting the biometric information associated with the user.

In an embodiment of the present disclosure, the biometric information is collected by scanning the biometric information associated with the user from one or more angles and one or more orientations in real-time.

In an embodiment of the present disclosure, the media device includes at least one of digital cameras, webcams, smart phones, laptops, closed-circuit television cameras and optical devices.

In an embodiment of the present disclosure, the biometric information associated with the user includes facial information, fingerprint impressions, hand geometry biometrics, retina scan, iris scan, signature and voice analysis.

In an embodiment of the present disclosure, the biometric authentication system facilitates in securing private and confidential information or assets of the user. The biometric authentication system is installed in a facility. The facility includes at least one of building, organization, institution, and skyscraper.

In a third example, a non-transitory computer-readable storage medium is provided. The non-transitory computer-readable storage medium encodes computer executable instructions that, when executed by at least one processor, performs a method. The method creates one or more hashes for the. The one or more hashes are created for performing biometric authentication in real-time. The computer-implemented method creates one or more hashes for a user. The one or more hashes are created for performing biometric authentication of the user in real-time. The non-transitory computer-readable storage medium includes a first step to collect biometric information associated with the user at a biometric authentication system with a processor. The non-transitory computer-readable storage medium includes another step to create one or more hashes based on the biometric information associated with the user. The non-transitory computer-readable storage medium includes another step to scan the biometric information associated the user. The non-transitory computer-readable storage medium includes another step to map the biometric information associated with the user scanned in real-time with the collected biometric information associated with the user. The non-transitory computer-readable storage medium includes another step to authenticate the user in real-time. The one or more hashes are created by encrypting the biometric information associated with the user. The one or more hashes are stored in a database. The one or more hashes are created for onboarding the user. The biometric authentication system scans the biometric information associated with the user in real-time. Scanning of the biometric information associated with the user is performed for authenticating the user in real-time. The biometric authentication system scans the biometric information associated with the user in real-time. Scanning of the biometric information associated with the user is performed for authenticating the user in real-time. The mapping is performed by recognizing and converting the biometric information associated with the user into the one or more hashes in real-time. The one or more hashes are mapped with the one or more hashes created by scanning the biometric information associated with the user. The authentication is performed for providing access to the user in real-time.

In an embodiment of the present disclosure, the biometric information is collected by scanning the biometric information associated with the user from one or more angles and one or more orientations in real-time.

In an embodiment of the present disclosure, the media device include at least one of digital cameras, webcams, smart phones, laptops, closed-circuit television cameras and optical devices.

In an embodiment of the present disclosure, the biometric information associated with the user includes facial information, fingerprint impressions, hand geometry biometrics, retina scan, iris scan, signature and voice analysis.

In an embodiment of the present disclosure, the biometric authentication system evaluates a measure of similarity between the one or more hashes created for the user in real-time with the one or more hashes created by analyzing the biometric information of the user. The evaluation of the measure of similarity is performed for authenticating the user in real-time.

In an embodiment of the present disclosure, the biometric authentication system sends one or more notifications to an administrator associated with the biometric authentication system. The one or more notifications are sent to the administrator in real-time.

### BRIEF DESCRIPTION OF THE FIGURES

Having thus described the invention in general terms, reference will now be made to the accompanying drawings, which are not necessarily drawn to scale, and wherein:

FIG. 1 illustrates an interactive computing environment for creating one or more hashes for biometric authentication in real-time, in accordance with various embodiments of the present disclosure;

FIG. 2 illustrates a flow chart for creating the one or more hashes for biometric authentication in real-time, in accordance with various embodiments of the present disclosure; and

FIG. 3 illustrates a block diagram of a computing device, in accordance with various embodiments of the present disclosure.

It should be noted that the accompanying figures are intended to present illustrations of exemplary embodiments of the present disclosure. These figures are not intended to limit the scope of the present disclosure. It should also be noted that accompanying figures are not necessarily drawn to scale.

### DETAILED DESCRIPTION

In the following description, for purposes of explanation, numerous specific details are set forth in order to provide a thorough understanding of the present technology. It will be apparent, however, to one skilled in the art that the present technology can be practiced without these specific details. In other instances, structures and devices are shown in block diagram form only in order to avoid obscuring the present technology.

Reference in this specification to “one embodiment” or “an embodiment” means that a particular feature, structure, or characteristic described in connection with the embodiment is included in at least one embodiment of the present technology. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments. Reference will now be made in detail to selected embodiments of the present disclosure in conjunction with accompanying figures. The embodiments described herein are not intended to limit the scope of the disclosure, and the present disclosure should not be construed as limited to the embodiments described. This disclosure may be embodied in different forms without departing from the scope and spirit of the disclosure. It should be understood that the accompanying figures are intended and provided to illustrate embodiments of the disclosure described below and are not necessarily drawn to scale. In the drawings, like numbers refer to like elements throughout, and thicknesses and dimensions of some components may be exaggerated for providing better clarity and ease of understanding.

It should be noted that the terms “first”, “second”, and the like, herein do not denote any order, quantity, or importance, but rather are used to distinguish one element from another. Further, the terms “a” and “an” herein do not denote a limitation of quantity, but rather denote the presence of at least one of the referenced item.

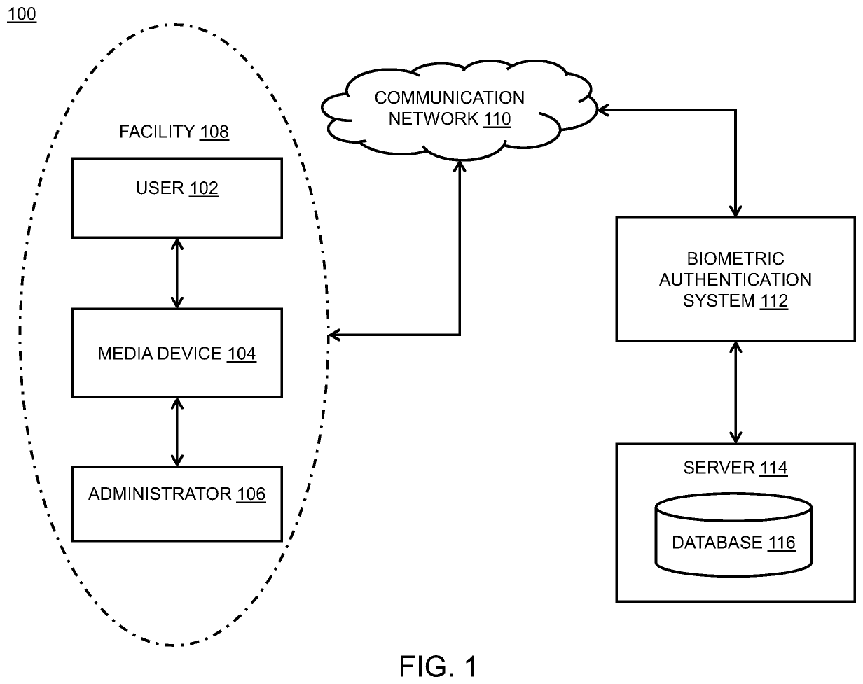

FIG. 1 illustrates a general overview of an interactive computing environment 100 for creating one or more hashes for biometric authentication in real-time, in accordance with various embodiments of the present disclosure. The interactive computing environment 100 provides a suitable environment to perform biometric authentication of users. The interactive computing environment 100 provides the suitable environment to perform secure biometric authentication of users. In general, biometric authentication is used for security purposes. In addition, biometric authentication includes but may not be limited to face recognition, fingerprint recognition, voice recognition and behavioral characteristics. Further, the biometric authentication is security process used to identify unique characteristics of any individual or any person. The interactive computing environment 100 includes a user 102, a media device 104 and an administrator 106. In addition, the interactive computing environment 100 includes a facility 108, a communication network 110, a biometric authentication system 112, a server 114 and a database 116.

The interactive computing environment 100 includes the user 102. The user 102 is any person or individual that wants to protect their private and confidential information. The user 102 is any person that wants to perform biometric authentication to protect their private and confidential information. In an embodiment of the present disclosure, the user 102 is any person that wants to perform facial identification to protect their private and confidential information. In another embodiment of the present disclosure, the user 102 is any person that wants to perform fingerprint authentication to protect their private and confidential information. In yet another embodiment of the present disclosure, the user 102 is any person that wants to perform retina scan to protect their private and confidential information. The user 102 is any person that wish to utilize the biometric authentication system 112 to protect their confidential assets. In an example, confidential information includes but may not be limited to secrets, trade secrets, any process, contracts, secret formulas, financial assets, non-financial assets, important documents and personal information. In another example, confidential assets include but may not be limited to gold, silver, platinum, and other valuable elements.

The interactive computing environment 100 includes the media device 104. The media device 104 includes but may not be limited to at least one of digital cameras, webcams, closed-circuit television cameras, optical devices, smart phones, tablets, laptops and personal digital assistants. In an example, webcam is type of media device capable of capturing videos or images for transmission over internet. In another example, digital camera is type of media device that uses image sensor to capture videos and still pictures in digital format. The media device 104 is utilized for purpose of scanning information or images. In an embodiment of the present disclosure, the media device 104 is used to scan face of the user 102 in real-time. In another embodiment of the present disclosure, the media device 104 is used to capture images and video clips of the user 102. In yet another embodiment of the present disclosure, the media device 104 is used to capture fingerprint of the user 102. In yet another embodiment of the present disclosure, the media device 104 is used to perform retina scan of the user 102.

The media device 104 is associated with the facility 108. In an embodiment of the present disclosure, the media device 104 is installed inside the facility 108. In another embodiment of the present disclosure, the media device 104 is installed around the facility 108. The facility 108 includes but may not be limited to at least one of building, organization, institution, and skyscraper. In an example, the facility 108 may be financial institution such as banks, central banks, retail and commercial banks, credit unions, savings, and loans associations, investment banks, investment companies, brokerage firms, insurance companies, and mortgage companies. In another example, the facility 108 is non-banking financial company. In yet another example, the facility 108 is any organization or building that stores and protects confidential information of the user 102.

In an embodiment of the present disclosure, the user 102 is associated with a communication device. In addition, the user 102 is owner of the communication device. The communication device is associated with the user 102. The communication device is operated by the user 102. In an embodiment of the present disclosure, the media device 104 is associated with the communication device. In another embodiment of the present disclosure, the media device 104 is embedded inside the communication device. In yet another embodiment of the present disclosure, the media device 104 is the communication device. In an embodiment of the present disclosure, the user 102 utilizes the communication device to access confidential information. In an example, the communication device includes but may not be limited to desktop, work station, smart phone, tablet, laptop and personal digital assistant. In an example, a user X is an owner of an organization. In addition, the user X has a business plan for enhancement of the organization. Further, the user X wants to secure the business plan in such a manner that only the user X may have access to the business plan. Furthermore, the user X utilizes the biometric authentication system 112 to secure the master business plan inside the facility 108.

The interactive computing environment includes the administrator 106. In an embodiment of the present disclosure, the administrator 106 is any person or individual associated with the biometric authentication system 112. In another embodiment of the present disclosure, the administrator 106 is any person that configures the biometric authentication system 112. In yet another embodiment of the present disclosure, the administrator 106 is any person that operates the biometric authentication system 112. In yet another embodiment of the present disclosure, the administrator 106 is any person responsible for upkeep and troubleshooting of the biometric authentication system 112.

In an embodiment of the present disclosure, the administrator 106 is present inside the facility 108. In another embodiment of the present disclosure, the administrator 106 is not present inside the facility 108.

The interactive computing environment 100 includes the communication network 110. The communication network 110 provides medium to the media device 104 to connect with the biometric authentication system 112. The communication network 110 use protocols to connect the media device 104 with the biometric authentication system 112. In an embodiment of the present disclosure, the communication network 110 facilitates transmission of biometric information of the user 102 to the biometric authentication system 112. The communication network 110 is used to provide internet or intranet access to the biometric authentication system 112.

In an embodiment of the present disclosure, the communication network 110 is any type of network that provides internet connectivity to the media device 104. In an embodiment of the present disclosure, the communication network 110 is a wireless mobile network. In another embodiment of the present disclosure, the communication network 110 is a wired network with a finite bandwidth. In yet another embodiment of the present disclosure, the communication network 110 is combination of the wireless and the wired network for optimum throughput of data transmission. In yet another embodiment of the present disclosure, the communication network 110 is an optical fiber high bandwidth network that enables high data rate with negligible connection drops.

The interactive computing environment 100 includes the biometric authentication system 112. The biometric authentication system 112 creates one or more hashes of the biometric information associated with the user 102. The biometric information associated with the user 102 includes facial information, fingerprint impressions, hand geometry biometrics, retina scan, iris scan, signature and voice analysis. The biometric authentication system 112 creates the one or more hashes to perform biometric authentication in real-time. In general, biometric authentication is a security process that relies on unique biological characteristics of an individual to verify that he is who he says he is. In an embodiment of the present disclosure, the biometric authentication system 112 compares the biometric information with confirmed authentic data stored in the database 116. In an embodiment of the present disclosure, the biometric authentication system 112 collects facial information of the user 102. The facial information of the user 102 is collected in real-time. The media device 104 is facilitated to collect the facial information of the user 102. In another embodiment of the present disclosure, the biometric authentication system 112 collects fingerprint impression of the user 102. The fingerprint impression of the user 102 is collected in real-time. The media device 104 is facilitated to collect the fingerprint impression of the user 102.

In an embodiment of the present disclosure, the biometric information associated with the user 102 is collected with facilitation of the media device 104. In an embodiment of the present disclosure, the biometric information of the user 102 is collected by scanning the biometric information of the user 102 from one or more angles and one or more orientations in real-time. In an embodiment of the present disclosure, the biometric information includes but may not be limited to facial expression, retina-scan, and fingerprint scan. In an embodiment of the present disclosure, the biometric information of the user 102 is collected from all possible angles. In another embodiment of the present disclosure, the biometric information of the user 102 is collected from all possible orientations.

In an example, the facial information of the user 102 is collected by scanning face of the user 102 from the one or more angles and the one or more orientations in real-time. In addition, the facial information of the user 102 is collected from all possible angles. Further, the facial information of the user 102 is collected from all possible orientations. In another example, fingerprint information of the user 102 is collected by scanning fingerprint impressions of the user 102 from the one or more angles and the one or more orientations in real-time. In addition, the fingerprint information of the user 102 is collected from all possible angles. Further, the fingerprint information of the user 102 is collected from all possible orientations. In yet another example, retina information of the user 102 is collected by scanning retina of the user 102 from the one or more angles and the one or more orientations in real-time. In addition, the retina information of the user 102 is collected from all possible angles. Further, the retina information of the user 102 is collected from all possible orientations.

In an embodiment of the present disclosure, the media device 104 facilitates to collect the biometric information of the user 102 from one or more sources. In addition, the one or more sources include but may not be limited to social media platforms, e-commerce websites, government identification documents and public records.

In an example, the social media platforms include Facebook, Instagram, Snapchat, Whatsapp, Twitter, LinkedIn, and other social media platforms. In another example, e-commerce websites include Amazon, Flipkart, Snapdeal, Ebay, and the like. In yet another example, the government identification documents include aadhar card, voter id card, social security card, birth certificate, social security card, voter id card, driving license, passport, welfare card, income tax card and any other important government related document.

The biometric authentication system 112 collects the biometric information of the user 102. The biometric information of user 102 is collected with facilitation of the media device 104. In addition, the biometric information of the user 102 is collected by the biometric authentication system 112 using the communication network 110 as medium.

The biometric authentication system 112 creates the one or more hashes for the biometric information associated with the user 102. In addition, the biometric authentication system 112 creates the one or more hashes in real-time. In general, hash is generated by using hashing algorithms. In addition, hashing algorithms use hash function to create hash value. Further, hash function is mathematical function that facilitates conversion of input value into numerical value or hash value. Furthermore, hash function converts input of any length into fixed strings. In an embodiment of the present disclosure, the biometric authentication system 112 facilitates generation of the one or more hashes using one or more hashing algorithms. In addition, the one or more hashing algorithms include but may not be limited to RipeMD, Tiger, xxhash, MD5, SHA-2, SHA-512, CRC32 and MD5. In an embodiment of the present disclosure, the biometric authentication system 112 stores the one or more hashes in the database 116.

The biometric authentication system 112 creates the one or more hashes by encrypting the biometric information of the user 102. The one or more hashes are created to onboard or register the user 102 with the biometric authentication system 112. In an embodiment of the present disclosure, the user 102 with the one or more hashes is registered or legitimate user. The biometric authentication system 112 facilitates in securing private and confidential information or assets of each registered user. In an embodiment of the present disclosure, the private and confidential information or assets include confidential documents, secret, financial assets, non-financial assets, important documents, personal information, trade secret, assets such as gold, silver, platinum and the like. In an embodiment of the present disclosure, the biometric authentication system 112 allows each registered user to access the private and confidential information and assets after authentication.

The biometric authentication system 112 performs authentication of the user 102 in real-time. The authentication is performed to provide access to the user 102 in real-time. In addition, the user 102 is authenticated by recognizing the biometric information associated with the user 102 in real-time. Further, the biometric information of the user 102 is converted into the one or more hashes by the biometric authentication system 112. Furthermore, the biometric authentication system 112 maps the biometric information associated with the user 102 scanned in real-time with the collected biometric information stored in the database 116. The mapping is performed by recognizing and converting the biometric information associated with the user 102 into the one or more hashes in real-time. The one or more hashes are mapped with the one or more hashes created by scanning the biometric information associated with the user 102. The biometric authentication system 112 authenticates the user 102 in real-time. The authentication is performed to provide access to the user 102 in real-time. In an embodiment of the present disclosure, the biometric authentication system 112 provides access to the user 102 in real-time that is the registered or legitimate user. In addition, the user 102 is provided access based on authentication of the legitimate user.

The interactive computing environment 100 includes the server 114. The biometric authentication system 112 is associated with the server 114. In an embodiment of the present disclosure, the server 114 is part of the biometric authentication system 112. In another embodiment of the present disclosure, the biometric authentication system 112 is installed at the server 114. The server 114 handles each operation and task performed by the biometric authentication system 112. The server 114 stores one or more instructions and one or more processes for performing various operations of the biometric authentication system 112. In an embodiment of the present disclosure, the server 114 is a cloud server. In general, cloud server is built, hosted and delivered through a cloud computing platform. In general, cloud computing is a process of using remote network server that are hosted on the internet to store, manage, and process data. The server 114 includes the database 116.

The database 116 is used for storage purposes. The database 116 is associated with the server 114. In general, database is a collection of information that is organized so that it can be easily accessed, managed and updated. In an embodiment of the present disclosure, the database 116 provides storage location to all data and information required by the biometric authentication system 112. The database 116 provides storage to the one or more hashes created for the facial features of the user 102. In an embodiment of the present disclosure, the database 116 may be at least one of hierarchical database, network database, relational database, object-oriented database and the like. However, the database 116 is not limited to the above-mentioned databases.

In an embodiment of the present disclosure, the biometric authentication system 112 creates a user profile for the user 102. The biometric authentication system 112 creates the user profile to store the one or more hashes created by encrypting the biometric information of the user 102. In general, user profile is a visual display of personal data associated with a specific user. The user profile stores the one or more hashes. In an embodiment of the present disclosure, the database 116 provides storage location to the user profile.

In an embodiment of the present disclosure, the biometric authentication system 112 updates the biometric information of each registered user. In an example, consider a government organization with a plurality of employees. In addition, the government organization is acquired with the biometric authentication system 112 for entry of the plurality of employees. Further, the biometric authentication system 112 is embedded with advanced technology that stores face of the plurality of employees as hash value in the database 116. Furthermore, the biometric authentication system 112 updates face of the plurality of employees based on age of the plurality of employees. In another example, user A and user B are employees of the government organization. In addition, the user A has age (say, 50) and the user B has age (say, 40). Further, the biometric authentication system 112 updates faces of the user A and the user B after every five years in the database 116. Furthermore, the biometric authentication system 112 updates faces of the plurality of employees for enhanced security of the government organization.

In an embodiment of the present disclosure, the biometric authentication system 112 sends one or more notifications to the administrator 106 associated with the biometric authentication system 112. The biometric authentication system 112 sends the one or more notifications in real-time. In an embodiment of the present disclosure, the one or more notifications are sent to the media device 104. In another embodiment of the present disclosure, the one or more notifications are sent to the communication device. In an embodiment of the present disclosure, the one or more notifications are sent as push notifications, OTA notifications, text messages, flash messages, audio messages, video messages, and the like.

In an example, consider a user A and an electronic device (say, a laptop). Further, the user A is associated with the electronic device which includes a digital camera. Furthermore, the user A wants to access a secured file that has been stored by using face as password. Moreover, the user A utilizes the digital camera associated with the electronic device to scan face of the user A. Moreover, the electronic device scans face of the user A and provides access of the secured file to the user A if the user A is authorized user. In another example, the user A access the stored secure file by using fingerprint impression. In yet another example, the user A access the stored secure file by using retina scan.

In an example, a biometric system (say, face recognition system) is used to secure personal data of the user 102. In addition, the biometric system scans face of the user 102 from various sources to extract facial features associated with the user 102. Further, the various sources include but may not be limited to private records and public records. Furthermore, the biometric system creates the one or more hashes for face of the user 102. In another example, the biometric system (say, fingerprint recognition system) is used to securer personal data of the user 102. In addition, the biometric system scans fingerprint impression of the user 102. Further, the biometric system creates the one or more hashes of the fingerprint impression of the user 102. Moreover, the biometric system secures personal data of the user 102 using the one or more hashes.

In an example, the biometric authentication system 112 creates one or more face models of face of the user 102. In addition, the one or more face models are created in real-time. Further, the one or more face models are created by analyzing the facial information of the user 102. Furthermore, the one or more face models are created based on one or more hardware-run algorithms. Moreover, the one or more hardware-run algorithms include but may not be limited to linear regression, logistic regression, decision tree, sum of vector machine, naïve Bayes, k nearest neighbor, random forest, time series, and k-means. In another example, the biometric authentication system 112 recognizes the one or more facial features from the facial information of the user 102 in real-time. In addition, the biometric authentication system 112 recognizes the one or more facial features based on evaluation of the one or more face models. Further, the one or more face models associated with the user 102 include the one or more facial features. Furthermore, the one or more facial features are associated with the facial information of the user 102. Moreover, the one or more facial features include at least one of jaw features, eye features, cheekbone features, eyebrow features, mouth features, chin features, forehead features, and the like.

In an example, consider a secure biometric system. In addition, the secure biometric system scans and stores facial data of the user 102 by converting the facial data of the user 102 into the one or more hashes. Moreover, the one or more hashes are created based on hashing algorithms. In another example, the secure biometric system scans and stores fingerprint impression of the user 102 by converting the fingerprint impression of the user 102 into the one or more hashes. Moreover, the one or more hashes are created based on hashing algorithms.

Further, the secure biometric system scans real-time face of the user 102. In addition, the secure biometric system scans the real-time face of the user 102 with facilitation of the media device 104. In another example, the secure biometric system performs real-time retina scan of the user 102. In addition, the secure biometric system performs the real-time retina scan of the user 102 with facilitation of the media device 104.

In an example, the user 102 is present inside the facility 108 during the real-time scanning of the biometric information of the user 102. In addition, the real-time scanning of the biometric information of the user 102 is performed to authenticate the user 102 in real-time. In another example, the user 102 is not present inside the facility 108 during the real-time scanning of the biometric information of the user 102.

Moreover, the secure biometric system performs authentication by recognizing and converting the one or more facial features of the user 102 into the one or more hashes in real-time. In addition, the converted one or more hashes associated with the user 102 are mapped with the one or more hashes created by analyzing the facial information of the user 102. Further, the secure biometric system evaluates a measure of similarity between the one or more hashes created for the user 102 in real-time with the one or more hashes created by analyzing the facial information of the user 102. Furthermore, the secure biometric system performs evaluation of the measure of similarity to authenticate the user 102 in real-time. In another example, the secure biometric system performs authentication by recognizing and converting retina information of the user 102 into the one or more hashes in real-time. In addition, the converted one or more hashes associated with the user 102 are mapped with the one or more hashes created by analyzing retina information of the user 102. Further, the secure biometric system evaluates a measure of similarity between the one or more hashes created for the user 102 in real-time with the one or more hashes created by analyzing the retina information of the user 102. Furthermore, the secure biometric system performs evaluation of the measure of similarity to authenticate the user 102 in real-time.

In an example, the one or more notifications are sent to the user 102 or the administrator 106 in case of face-spoofing. In addition, face-spoofing is attempted by fraudulent users to access the private and confidential information of the registered or legitimate user.

In yet another example, the user 102 is associated with a banking system. In addition, the user 102 is registered with the banking system. Further, the banking system is equipped with the biometric authentication system 112 to provide enhanced security to data associated with the user 102. Furthermore, the biometric authentication system 112 stores password for the user 102 by converting the biometric information of the user 102 into the one or more hashes. The one or more hashes are generated for the user 102 using hash function. Furthermore, the biometric authentication system 112 used by the banking system provides protection to data of the user 102 from spoof attack attempted by fraudulent users.

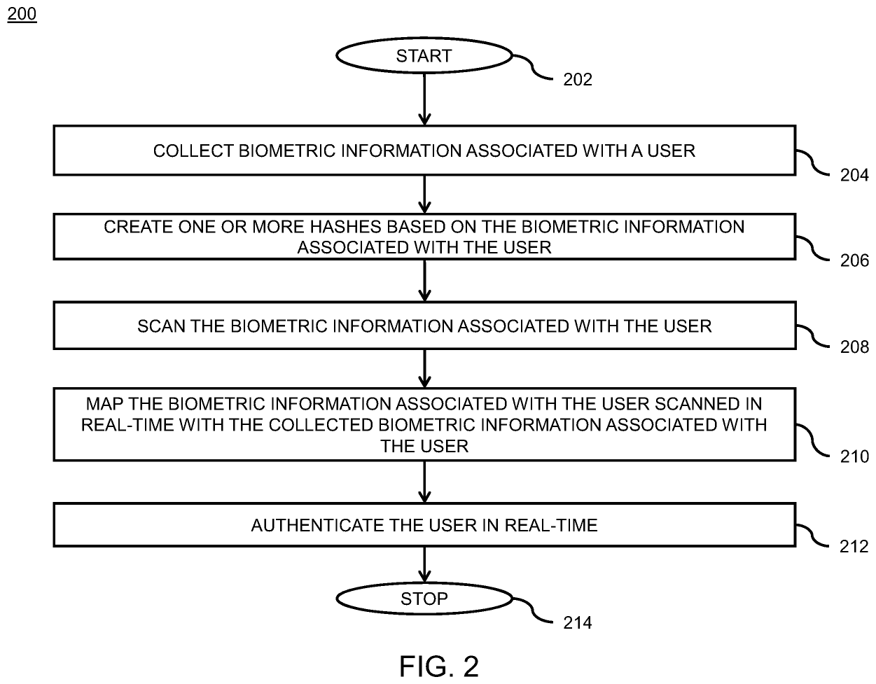

FIG.2 illustrates a flow chart 200 for creating the one or more hashes for biometric authentication in real-time, in accordance with various embodiments of the present disclosure. It may be noted that to explain the process steps of flowchart 200, references will be made to the system elements of FIG. 1. It may also be noted that the flowchart 200 may have fewer or more number of steps.

The flow chart 200 initiates at step 202. Following step 202, at step 204, the biometric authentication system 112 collects the biometric information of the user 102. At step 206, the biometric authentication system 112 creates the one or more hashes based on the biometric information associated with the user 102.in real-time. At step 208, the biometric authentication system 112 scans the biometric information of the user 102 in real-time. At step 210, the biometric authentication system 112 maps the biometric information associated with the user scanned in real-time with the collected biometric information associated with the user 102. At step 212, the biometric authentication system 112 authenticates the user 102 in real-time. The flow chart terminates at step 214.

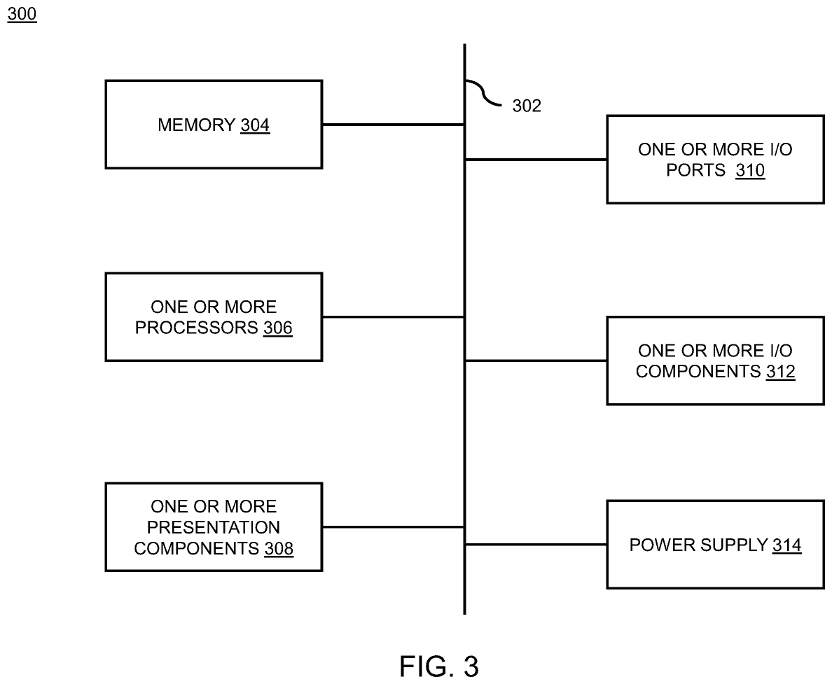

FIG. 3 illustrates a block diagram of a computing device 300, in accordance with various embodiments of the present disclosure. The computing device 300 includes a bus 302 that directly or indirectly couples the following devices: memory 304, one or more processors 306, one or more presentation components 308, one or more input/output (I/O) ports 310, one or more input/output components 312, and an illustrative power supply 314. The bus 302 represents what may be one or more busses (such as an address bus, data bus, or combination thereof). Although the various blocks of FIG. 3 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art and reiterate that the diagram of FIG. 3 is merely illustrative of an exemplary computing device 300 that can be used in connection with one or more embodiments of the present invention. Distinction is not made between such categories as “workstation,” “server 114,” “laptop,” “hand-held device,” etc., as all are contemplated within the scope of FIG. 3 and reference to “computing device.”

The computing device 300 typically includes a variety of computer-readable media. The computer-readable media can be any available media that can be accessed by the computing device 300 and includes both volatile and nonvolatile media, removable and non-removable media. By way of example, and not limitation, the computer-readable media may comprise computer storage media and communication media. The computer storage media includes volatile and nonvolatile, removable and non-removable media implemented in any method or technology for storage of information such as computer-readable instructions, data structures, program modules or other data. The computer storage media includes, but is not limited to, non-transitory computer-readable storage medium that stores program code and/or data for short periods of time such as register memory, processor cache and random access memory (RAM), or any other medium which can be used to store the desired information and which can be accessed by the computing device 300. The computer storage media includes, but is not limited to, non-transitory computer readable storage medium that stores program code and/or data for longer periods of time, such as secondary or persistent long term storage, like read only memory (ROM), EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing device 300. The communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 304 includes computer-storage media in the form of volatile and/or nonvolatile memory. The memory 304 may be removable, non-removable, or a combination thereof. Exemplary hardware devices include solid-state memory, hard drives, optical-disc drives, etc. The computing device 300 includes the one or more processors 306 that read data from various entities such as memory 304 or I/O components 312. The one or more presentation components 308 present data indications to a user or other device. Exemplary presentation components include a display device, speaker, printing component, vibrating component, etc. The one or more I/O ports 310 allow the computing device 300 to be logically coupled to other devices including the one or more I/O components 312, some of which may be built in. Illustrative components include a microphone, joystick, game pad, satellite dish, scanner, printer, wireless device, etc.

The foregoing descriptions of specific embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

While several possible embodiments of the invention have been described above and illustrated in some cases, it should be interpreted and understood as to have been presented only by way of illustration and example, but not by limitation. Thus, the breadth and scope of a preferred embodiment should not be limited by any of the above-described exemplary embodiments.

What is claimed is:

1. A computer-implemented method for creating one or more hashes for a user, wherein the one or more hashes are created for performing biometric authentication of the user in real-time, the computer-implemented method comprising:
collecting, at a biometric authentication system with a processor, biometric information associated with a user, wherein the biometric information associated with the user is collected in real-time, wherein the biometric information associated with the user is collected with facilitation of media device;
creating, at the biometric authentication system with the processor, one or more hashes based on the biometric information associated with the user, wherein the one or more hashes are created by encrypting the biometric information associated with the user, wherein the one or more hashes are stored in a database, wherein the one or more hashes are created for onboarding the user with the biometric authentication system;
scanning, at the biometric authentication system with the processor, the biometric information associated the user, wherein the biometric authentication system scans the biometric information associated with the user in real-time, wherein the scanning of the biometric information associated with the user is performed for authenticating the user in real-time;
mapping, at the biometric authentication system with the processor, the biometric information associated with the user scanned in real-time with the collected biometric information associated with the user, wherein the mapping is performed by recognizing and converting the biometric information associated with the user into the one or more hashes in real-time, wherein the one or more hashes are mapped with the one or more hashes created by scanning the biometric information associated with the user; and
authenticating, at the biometric authentication system with the processor, the user in real-time based on the mapping, wherein the authentication is performed for providing access to the user in real-time.

2. The computer-implemented method as recited in claim 1, further comprising generating, at the biometric authentication system with the processor, a user profile of the user, wherein the user profile is generated for storing the one or more hashes created by encrypting the biometric information associated with the user in real-time.

3. The computer-implemented method as recited in claim 1, wherein the biometric information is collected by scanning the biometric information associated with the user from one or more angles and one or more orientations in real-time.

4. The computer-implemented method as recited in claim 1, wherein the media device comprises at least one of digital cameras, webcams, smart phones, laptops, closed-circuit television cameras and optical devices.

5. The computer-implemented method as recited in claim 1, wherein the biometric information associated with the user comprises at least one of facial information, fingerprint impressions, hand geometry biometrics, retina scan, iris scan, signature and voice analysis.

6. The computer-implemented method as recited in claim 1, wherein the biometric authentication system facilitates in securing private and confidential information or assets of the user, wherein the biometric authentication system is installed at a facility, wherein the facility comprises at least one of building, organization, institution, and skyscraper.

7. The computer-implemented method as recited in claim 1, further comprising evaluating, at the biometric authentication system with the processor, a measure of similarity between the one or more hashes scanned for the user in real-time with the one or more hashes created by analyzing the biometric information associated with the user, wherein the evaluation of the measure of similarity is performed for authenticating the user in real-time.

8. The computer-implemented method as recited in claim 1, further comprising sending, at the biometric authentication system with the processor, one or more notifications to an administrator associated with the biometric authentication system, wherein the one or more notifications are sent to the administrator in real-time.

9. A computer system comprising:
one or more processors; and
a memory coupled to the one or more processors, the memory for storing instructions which, when executed by the one or more processors, cause the one or more processors to perform a method for creating one or more hashes for a user, wherein the one or more hashes are created for performing biometric authentication in real-time, the computer-implemented method comprising:
collecting, at a biometric authentication system, biometric information associated with a user, wherein the biometric information associated with the user is collected in real-time, wherein the biometric information associated with the user is collected with facilitation of media device;
creating, at the biometric authentication system, one or more hashes based on the biometric information associated with the user, wherein the one or more hashes are created by encrypting the biometric information associated with the user, wherein the one or more hashes are stored in a database, wherein the one or more hashes are created for onboarding the user with the biometric authentication system;
scanning, at the biometric authentication system, the biometric information associated the user, wherein the biometric authentication system scans the biometric information associated with the user in real-time, wherein the scanning of the biometric information associated with the user is performed for authenticating the user in real-time;
mapping, at the biometric authentication system, the biometric information associated with the user scanned in real-time with the collected biometric information associated with the user, wherein the mapping is performed by recognizing and converting the biometric information associated with the user into the one or more hashes in real-time, wherein the one or more hashes are mapped with the one or more hashes created by scanning the biometric information associated with the user; and
authenticating, at the biometric authentication system, the user in real-time based on the mapping, wherein the authentication is performed for providing access to the user in real-time.

10. The computer system as recited in claim 9, further comprising generating, at the biometric authentication system, a user profile the user, wherein the user profile is generated for storing the one or more hashes created by encrypting the biometric information associated with the user.

11. The computer system as recited in claim 9, wherein the biometric information is collected by scanning the biometric information associated with the user from one or more angles and one or more orientations in real-time.

12. The computer system as recited in claim 9, wherein the media device comprises at least one of digital cameras, webcams, smart phones, laptops, closed-circuit television cameras and optical devices.

13. The computer system as recited in claim 9, wherein the biometric information associated with the user comprises facial information, fingerprint impressions, hand geometry biometrics, retina scan, iris scan, signature and voice analysis.

14. The computer system as recited in claim 9, wherein the biometric authentication system facilitates in securing private and confidential information or assets of the user, wherein the biometric authentication system is installed in a facility, and wherein the facility comprises at least one of building, organization, institution, and skyscraper.

15. A non-transitory computer-readable storage medium encoding computer executable instructions that, when executed by at least one processor, performs a method for creating one or more hashes for a user, wherein the one or more hashes are created for performing biometric authentication in real-time, the computer-implemented method comprising:
collecting, at a computing device, biometric information associated with a user, wherein the biometric information associated with the user is collected in real-time, wherein the biometric information associated with the user is collected with facilitation of media device;
creating, at the computing device, one or more hashes based on the biometric information associated with the user, wherein the one or more hashes are created by encrypting the biometric information associated with the user, wherein the one or more hashes are stored in a database, wherein the one or more hashes are created for onboarding the user with a biometric authentication system;
scanning, at the computing device, the biometric information associated the user, wherein the biometric authentication system scans the biometric information associated with the user in real-time, wherein the scanning of the biometric information associated with the user is performed for authenticating the user in real-time;
mapping, at the computing device, the biometric information associated with the user scanned in real-time with the collected biometric information associated with the user, wherein the mapping is performed by recognizing and converting the biometric information associated with the user into the one or more hashes in real-time, wherein the one or more hashes are mapped with the one or more hashes created by scanning the biometric information associated with the user; and
authenticating, at the computing device, the user in real-time based on the mapping, wherein the authentication is performed for providing access to the user in real-time.

16. The non-transitory computer-readable storage medium as recited in claim 15, wherein the biometric information is collected by scanning the biometric information associated with the user from one or more angles and one or more orientations in real-time.

17. The non-transitory computer-readable storage medium as recited in claim 15, wherein the media device comprises at least one of digital cameras, webcams, smart phones, laptops, closed-circuit television cameras and optical devices.

18. The non-transitory computer-readable storage medium as recited in claim 15, wherein the biometric information associated with the user comprises facial information, fingerprint impressions, hand geometry biometrics, retina scan, iris scan, signature and voice analysis.

19. The non-transitory computer-readable storage medium as recited in claim 15, further comprising evaluating, at the biometric authentication system, a measure of similarity between the one or more hashes created for the user in real-time with the one or more hashes created by analyzing the biometric information of the user, wherein the evaluation of the measure of similarity is performed for authenticating the user in real-time.

20. The computer-implemented method as recited in claim 15, further comprising sending, at the biometric authentication system, one or more notifications to an administrator associated with the biometric authentication system, wherein the one or more notifications are sent to the administrator in real-time.
